(19) United States
(12) Patent Application Publication
(10) Pub. No.: US 2010/0081010 A1
(43) Pub. Date: Apr. 1, 2010

(54) IMPRINT MOLD STRUCTURE, MAGNETIC RECORDING MEDIUM AND METHOD FOR PRODUCING THE MAGNETIC RECORDING MEDIUM

(75) Inventors: ATSUSHI TATSUGAWA, Kanagawa (JP); KENJI ICHIKAWA, Kanagawa (JP)

Correspondence Address: YOUNG & THOMPSON, 209 Madison Street, Suite 500, Alexandria, VA, 22314, US

(73) Assignee: FUJIFILM CORPORATION, TOKYO (JP)

(21) Appl. No.: 12/567,077

(22) Filed: Sep. 25, 2009

(30) Foreign Application Priority Data
Sep. 26, 2008 (JP) 2008-249019

(51) Int. Cl. G11B 5/74; B29C 33/00; B29C 59/02

(52) U.S. Cl. 428/800; 425/470; 264/293

(57) ABSTRACT

To provide an imprint mold structure for producing a magnetic recording medium, the imprint mold structure including: a first pattern corresponding to servo areas, a second pattern corresponding to data areas, and a shape corresponding to one or more non-patterned areas, wherein the magnetic recording medium includes the servo areas where servo data is to be recorded, and the data areas which include a pattern to write user data on, and wherein the data areas have the one or more non-patterned areas which do not include a pattern to write user data on and which are substantially concentric areas each composed of two or more adjacent tracks located in the data areas.

### BACKGROUND OF THE INVENTION

1. Field of the Invention

The present invention relates to an imprint mold structure, a magnetic recording medium produced using the imprint mold structure, and a method for producing the magnetic recording medium.

2. Description of the Related Art

The formation of servo and data tracks on a magnetic recording medium by the use of a magnetic head has been problematic in that the formation is greatly affected by the write width and read width of the magnetic head. Thus, in decreasing the data track width to enable a hard disk drive (HDD) to have a large capacity, effects of magnetism between adjacent tracks (crosstalk) and effects of heat fluctuation are noticeable, and increase in surface recording density by decrease in the magnetic head width is limited. As a means for solving these problems, magnetic recording media referred to as discrete track media (DTM) have been proposed (refer to Japanese Patent Application Laid-Open (JP-A No. 56-119934, for example).

The DTM are each produced by imprinting a resist-coated magnetic recording medium with a concavo-convex pattern provided on an imprint mold structure (hereinafter also referred to as “mold structure” for short), and processing a magnetic layer of the magnetic recording medium while the resist to which the concavo-convex pattern of the mold structure has been transferred serves as a mask, so as to form a desired magnetic pattern.

Parenthetically, in an HDD, a recording and reproduction area exclusively used by the maker of the drive (hereinafter, this area is also referred to as “maker-only area”) and inaccessible by general users is prepared. This maker-only area is an extremely important area where information such as head parameters, channel parameters, servo parameters and a trick pitch that are unique to each drive and measured at the time of a production test, microcode used to operate a drive designed by the drive maker, operational information at the time of use by a user based upon microcode, provided for the purpose of predicting a breakdown and finding trouble early by SMART (self-monitoring, analysis and reporting technology), and the like are recorded. It should be particularly noted that in the drive after the power has been turned on, boot microcode recorded on a mask ROM is read out, then a head accesses the maker-only area on the disk and reads out microcode necessary for subsequent operation; therefore, when the maker-only area is impossible to read, booting is impossible. For this reason, the track pitch and the bit pitch in the maker-only area are often designed so as to have a margin, in contrast to other portions for user data.

However, as to a magnetic recording medium formed by imprinting using an imprint mold structure having servo areas and data areas, since data is recorded in the physically formed data areas by using a magnetic head, tracks on the magnetic recording medium are physical tracks formed in advance, not tracks magnetically formatted by a head after installed in the drive, and thus it is inferred that the effects of eccentricity and displacement make it difficult to position the head accurately at the center of each track. Accordingly, measures may have to be taken to solve this problem.

### BRIEF SUMMARY OF THE INVENTION

An object of the present invention is to provide an imprint mold structure for producing a magnetic recording medium wherein data areas have one or more non-patterned areas which do not include a pattern to write user data on, thereby making it possible to avoid, particularly in a maker-only area where information important to boot and control an HDD is recorded and reproduced, the risk of causing recording and/or reproduction failure attributable to offsetting of a trace of a head and a trace of a patterned track in the non-patterned area(s), and thus possible to remove booting failure and operation failure that are serious problems with the HDD; a magnetic recording medium produced using the imprint mold structure; and a method for producing the magnetic recording medium.

The present invention is based upon the findings of the present inventors, and means for solving the problems are as follows.

Means for solving the problems are as follows.

<1> An imprint mold structure for producing a magnetic recording medium, the imprint mold structure including: a first pattern corresponding to servo areas, a second pattern corresponding to data areas, and a shape corresponding to one or more non-patterned areas, wherein the magnetic recording medium includes the servo areas where servo data is to be recorded, and the data areas which include a pattern to write user data on, and wherein the data areas have the one or more non-patterned areas which do not include a pattern to write user data on and which are substantially concentric areas each composed of two or more adjacent tracks located in the data areas.
<2> The imprint mold structure according to <1>, wherein each pattern is one of a discrete pattern and a dot pattern.
<3> The imprint mold structure according to <1>, wherein the one or more non-patterned areas are provided in at least any one of an inner circumferential part, an intermediate circumferential part and an outer circumferential part of the magnetic recording medium with respect to a radius direction.
<4> A method for producing a magnetic recording medium, including: using an imprint mold structure for producing a magnetic recording medium, the imprint mold structure including a first pattern corresponding to servo areas, a second pattern corresponding to data areas, and a shape corresponding to one or more non-patterned areas, wherein the magnetic recording medium includes the servo areas where servo data is to be recorded, and the data areas which include a pattern to write user data on, and wherein the data areas have the one or more non-patterned areas which do not include a pattern to write user data on, and which are substantially concentric areas each composed of two or more adjacent tracks located in the data areas.
<5> A magnetic recording medium obtained by a method for producing a magnetic recording medium, the method including: using an imprint mold structure for producing a magnetic recording medium, the imprint mold structure including a first pattern corresponding to servo areas, a second pattern corresponding to data areas, and a shape corresponding to one or more non-patterned areas, wherein the magnetic recording medium includes the servo areas where servo data is to be recorded, and the data areas which include a pattern to write user data on, and wherein the data areas have the one or more non-patterned areas which do not include a pattern to write user data on, and which are substantially concentric areas each composed of two or more adjacent tracks located in the data areas.

Here, as to a discrete track medium (DTM), when an unusable track exists owing to a disk defect, imprinting failure and/or variation in track width, there is a higher risk that it is impossible to provide a maker-only area, which is prepared for drive control and on which general data cannot be recorded, in the same radius position and on a continuous track.

In the present invention, since the non-patterned area(s) is/are concentric area(s) each composed of two or more adjacent tracks located, in the data areas, the maker-only area can be surely placed with a predetermined cylinder address value and in a predetermined radius position, and an access cylinder at the time of booting in the hard disk drive can be set as microcode in advance, so that an algorithm for seeking the cylinder can be omitted. Also, provision of the cylinder on the adjacent tracks makes it possible to reduce seek time loss at the times of reading and writing and thus to improve performance.

Additionally, the non-patterned area(s) can also be utilized for measuring head parameters, servo parameters and clearances at the time of a production test, recording drive-related information such as information about a defect on the disk and address information, and replacing information read out with difficulty in the case where the information from a user data portion is hard to read out for some reason, for example owing to a defect on the disk.

Also, when a non-patterned area having a width of 100 μm or greater is formed, the state in which the head flies varies at a boundary portion of the area, and thus the head often comes into contact with the magnetic recording medium. To enable recording and reproduction of user information without causing variation of the state in which the head flies, the present inventors have found that formation of non-patterned areas in a divided manner is effective when a non-patterned area having a width of 100 μm or greater is required.

According to the present invention, it is possible to solve the problems in related art and provide an imprint mold structure for producing a magnetic recording medium wherein data areas have one or more non-patterned areas which do not include a pattern to write user data on, thereby making it possible to avoid, particularly in a maker-only area where information important to boot and control an HDD is recorded and reproduced, the risk of causing recording and/or reproduction failure attributable to offsetting of a trace of a head and a trace of a patterned track in the non-patterned area(s), and thus possible to remove booting failure and operation failure that are serious problems with the HDD; a magnetic recording medium produced using the imprint mold structure; and a method for producing the magnetic recording medium.

### BRIEF DESCRIPTION OF THE DRAWINGS

FIG. 1 is a plan view schematically showing an example of the structure of a magnetic recording medium of the present invention.

FIG. 2 is a plan view schematically showing another example of the structure of a magnetic recording medium of the present invention.

FIG. 3 is a plan view schematically showing yet another example of the structure of a magnetic recording medium of the present invention.

FIG. 4 is a drawing showing in an enlarged manner a data area and a servo area of the magnetic recording medium shown in FIG. 1.

FIG. 5 is a drawing for explaining the servo area shown in FIG. 4.

FIG. 6 is a plan view schematically showing the structure of an imprint mold structure of the present invention.

FIG. 7 is a plan view partially showing components of the imprint mold structure of the present invention.

FIG. 8A is a cross-sectional view showing a method for producing an imprint mold structure of the present invention.

FIG. 8B is a cross-sectional view showing the method for producing the imprint mold structure of the present invention.

FIG. 9 is a cross-sectional view showing a method for producing a magnetic recording medium, using the imprint mold structure of the present invention.

### DETAILED DESCRIPTION OF THE INVENTION

### Imprint Mold Structure

An imprint mold structure of the present invention is for producing a magnetic recording medium including servo areas where servo data is to be recorded, and data areas which include a pattern to write user data on, wherein the data areas have one or more non-patterned areas which do not include a pattern to write user data on.

The imprint mold structure includes a first pattern corresponding to the servo areas, a second pattern corresponding to the data areas, and a shape corresponding to the one or more non-patterned areas.

### <Servo Area>

Each of the servo areas is divided into a preamble portion, an address portion and a burst portion.

The preamble portion is where information for synchronization of a clock of a reproduction signal is recorded.

The address portion is where a servo signal recognition code (so-called “servo mark”), sector information, cylinder information and the like are formed by Manchester code at the same pitch as in the preamble portion with respect to a circumferential direction. The cylinder information is such a pattern that the information varies from servo track to servo track. Accordingly, in order to reduce effects of an error in deciphering an address at the time of head seek operation, the cylinder information is converted to a code called gray code which minimizes the variation between adjacent tracks, and then recorded as Manchester code.

The burst portion is an off-track detecting region to detect the off-track amount in an on-track state of a cylinder address, and four marks that are called A burst, B burst, C burst and D burst, with their pattern phases being shifted from one another in a diameter direction, are formed in the burst portion. In each burst, a plurality of marks are disposed in the circumferential direction with the same pitch period as in the preamble portion, and the period with respect to the diameter direction is set so as to be in proportion to the variation period of all address pattern, in other words in proportion to the servo track period. In the present invention, each burst is formed so as to cover 10 periods in the circumferential direction and is repeated in the diameter direction with a period which is twice as large as the servo track period.

### <Data Area>

The data areas are areas which include a pattern to write user data on.

The data areas have non-patterned area(s) which does/do not include a pattern to write user data on.

The pattern is preferably either a discrete pattern or a dot pattern. This means that the imprint mold structure of the present invention can be suitably used to produce both discrete track media (DTM) and bit patterned media (BPM).

### <Non-Patterned Area>

The non-patterned area(s) is/are area(s) which does/do not include a pattern to write user data on and is/are located in the data areas. In the data areas (data areas lying between the servo areas), the non-patterned area(s) is/are substantially concentric area(s) each composed of two or more adjacent tracks, preferably composed of approximately 100 tracks. It should, however, be noted that the number of tracks varies depending upon the amount of memory required by the drive maker. In the case where the number of tracks constituting the non-patterned area(s) is less than two, recording and/or reproduction failure may arise when a trace of a head gets off the patterned track, and thus there is a higher risk that the drive fails to boot and operate.

The non-patterned area(s) is/are preferably provided in at least any one of an inner circumferential part, an intermediate circumferential part and an outer circumferential part of the magnetic recording medium with respect to a radius direction. The inner circumferential part means the innermost part of the discretely formed data areas predetermined according to a track format, or a region situated nearer to the center than the innermost part by the number of tracks equivalent to the amount of memory required as a maker-only area. The intermediate circumferential part means a region sandwiched between the discretely formed data areas, for example a region in a radius position where the head skew is zero. The outer circumferential part means the outermost part of the discretely formed data areas, or a region situated nearer to the edge than the outermost part by the number of tracks equivalent to the amount of memory required as the maker-only area.

For instance, the intermediate circumferential part where the head skew is zero is used for a non-patterned area. The head skew is calculated by measuring the distance between the center of a spindle motor and the center of a head arm pivot, and the distance between the center of the head arm pivot and an end of a head element. In contrast to the track pitch in the data areas, a track pitch with a margin whereby reading and writing are surely enabled regardless of differences among heads is designed in the non-patterned area, and the required width of the non-patterned area can be calculated from the track pitch.

The number of tracks constituting the non-patterned areas) is calculated from the number of required memory bits allotted to a special cylinder.

Assuming that the radius position in the intermediate circumferential part where the head skew is zero is 22 mm, the number of tracks required is 100, and the track pitch with a margin is 100 nm while the track pitch in the data areas is 80 nm, the data areas in radius positions between 22.01 mm and 21.99 mm, sandwiched between the servo areas, are formed as a non-patterned area. When the track pitch is decided, cylinder addresses are decided as well, so that an area lying between the decided cylinder addresses can be surely set as a non-patterned area.

The information recorded in the non-patterned area(s) is not particularly limited unless it is user data, and may be suitably selected according to the purpose. Examples thereof include information such as head parameters, channel parameters, servo parameters and a trick pitch that are unique to each drive and measured at the time of a production test, microcode used to operate a drive designed by the drive maker, and operational information at the time of use by a user based upon microcode, provided for the purpose of predicting a breakdown and finding trouble early by SMART (self-monitoring, analysis and reporting technology).

The information is recorded in the non-patterned area(s) so as to have a shape corresponding to the non-patterned area(s). The shape may be physically written or recorded using a magnetic head for each drive, for example. Note that when information is not written in the non-patterned area(s), the non-patterned area(s) may remain blank.

Examples of the physical writing include a method of nanoimprinting a magnetic recording medium with a desired concavo-convex pattern provided on a mold structure and then etching the magnetic recording medium so as to form the shape.

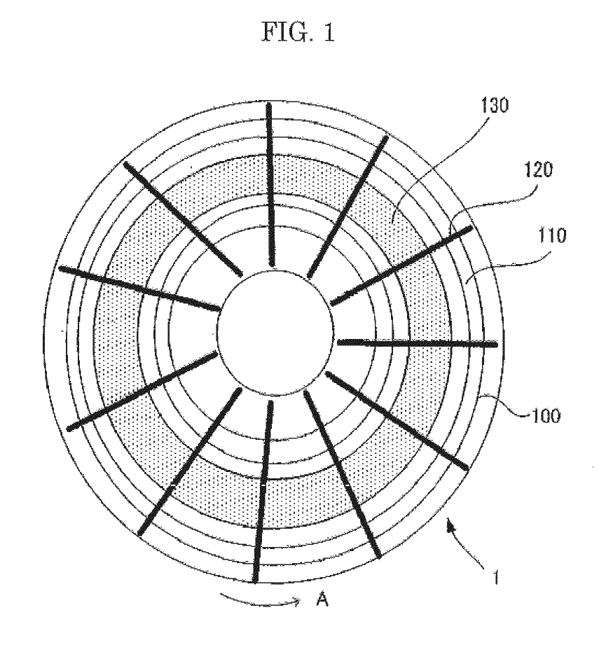

Here, FIG. 1 is a plan view schematically showing an example of the structure of a magnetic recording medium of the present invention.

In FIG. 1, a magnetic recording medium 1 includes a plurality of tracks 100 concentrically provided, a plurality of servo areas 120 formed in a substantially radial manner, a plurality of data areas 110 separated from one another by the servo areas 120, and a non-patterned area 130, and, if necessary, includes other member(s).

The magnetic recording medium 1 in FIG. 1 includes the non-patterned area 130 which is a concentric area composed of two or more adjacent tracks located in the data areas. The direction of the arrow A in FIG. 1 represents a circumferential direction.

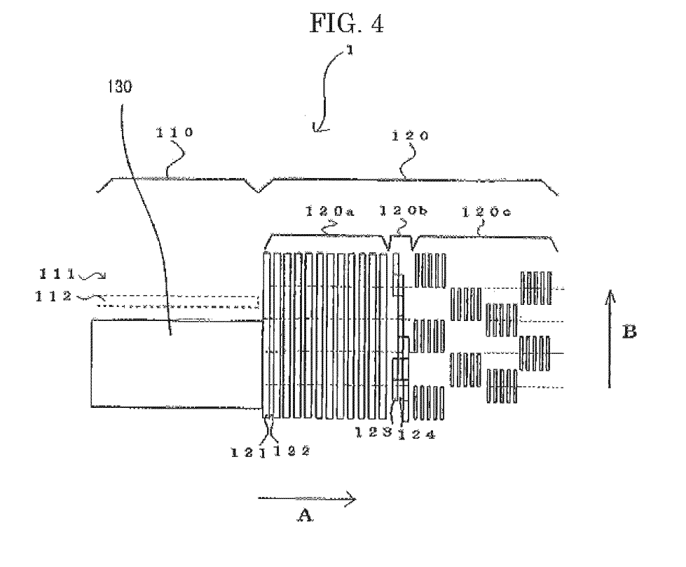

FIG. 4 is a drawing showing, in an enlarged manner, one of the data areas 110, one of the servo areas 120 and the non-patterned area 130 of the magnetic recording medium 1 shown in FIG. 1. The direction of the arrow A and the direction of the arrow B in FIG. 4 represent a circumferential direction and a radius direction respectively.

In FIG. 4, the magnetic recording medium 1 has a structure in which the data area 110 and, the non-patterned area 130 are disposed in parallel with each servo area 120 with respect to the track direction,

### —Data Area—

The data areas 110 are areas where user data can be written by using a magnetic head of a magnetic recording and reproducing apparatus.

In each data area 110, a plurality of tracks including a magnetic band 111 where user data can be written by using the magnetic head are provided, and a nonmagnetic band 112 where use data cannot be written is provided between each adjacent track. In other words, the magnetic recording medium is a discrete track recording medium in which the magnetic band 111 is physically divided by the nonmagnetic band 112.

### —Servo Area—

The servo areas 120 are areas where servo data utilized to perform positional detection on the magnetic recording medium using the magnetic head of the magnetic recording and reproducing apparatus is recorded in advance.

In each servo area 120, magnetic portions 122 and 124 and nonmagnetic portions 121 and 123 are formed by whole-surface transfer using an imprint mold structure (stamper) when the magnetic recording medium is produced, and the nonmagnetic portions 121 and 123 are filled with a nonmagnetic material. In the case where servo data in the servo area 120 is reproduced using a magnetic head of a magnetic recording and reproducing apparatus, the magnetic portions 122 and 124 are reproduced as the binary value “0”, whereas the nonmagnetic portions 121 and 123 are reproduced as the binary value “1”.

The servo area 120 includes a preamble area 120a, an address area 120b and a burst area 120c, as shown in FIG. 4.

The magnetic recording medium 1 records information in accordance with a perpendicular magnetic recording method in which a magnetic film is magnetized in a perpendicular direction (thickness direction of the medium) at the magnetic portions 122 and 124 and the magnetic band 111. In the magnetic recording medium 1, the nonmagnetic band 112 and the nonmagnetic portions 121 and 123 are filled with a nonmagnetic material; it should, however, be noted that these may be formed as empty spaces instead of being filled with the nonmagnetic material.

The preamble area 120a is an area where servo data for clock synchronization is recorded, and the magnetic portion 122 corresponding to the code “1” of the servo data, and the nonmagnetic portion 121 corresponding to the code “0” of the servo data are formed. The preamble area 120a is read out by the magnetic head earlier than the address area 120b and the burst area 120c are.

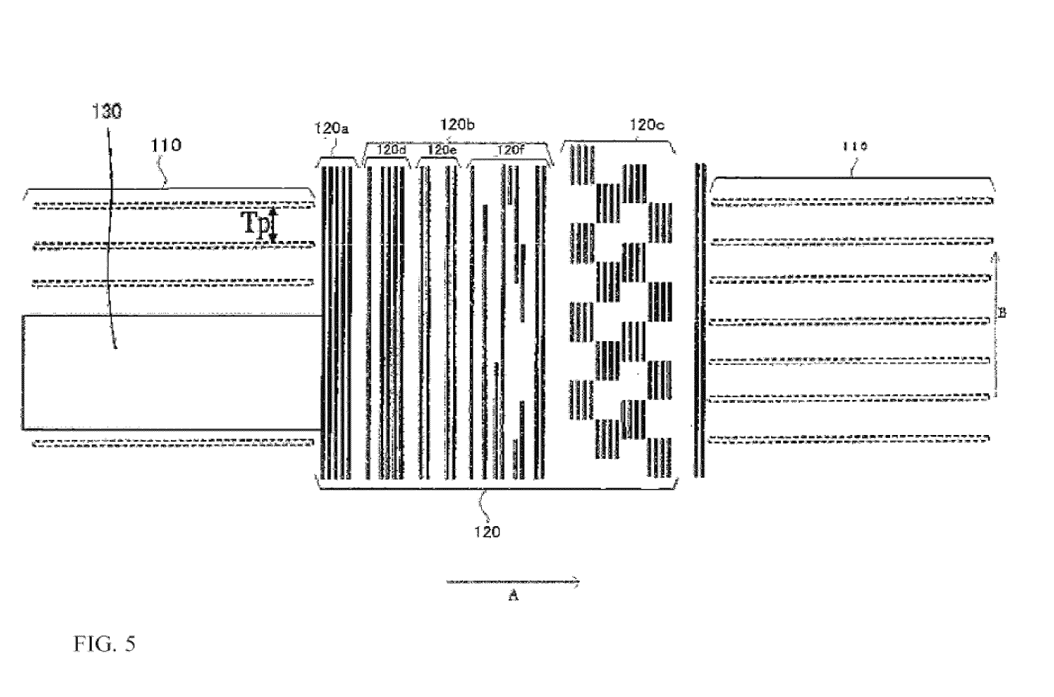

The address area 120b is an area where servo data including a code as a servo mark 120d, sector information 120e, cylinder information 120f and the like (as shown in FIG. 5) is recorded by Manchester encoding in which the binary value “0” is represented as the code “01” and the binary value “1” is represented as the code “10”. In the address area 120b, the nonmagnetic portion 123 and the magnetic portion 124 corresponding to the codes “1” and “0” respectively, regarding Manchester encoding of the servo data, are formed.

The burst area 120c is an area where servo data for obtaining information about a positional deviation concerning the position of the magnetic head relative to the central position of a track is recorded.

### —Non-Patterned Area—

The non-patterned area 130 is not particularly limited as long as it is provided in the data areas 110, and may be suitably selected according to the purpose. The non-patterned area 130 is preferably provided as an area composed of two or more adjacent tracks between the servo areas 120.

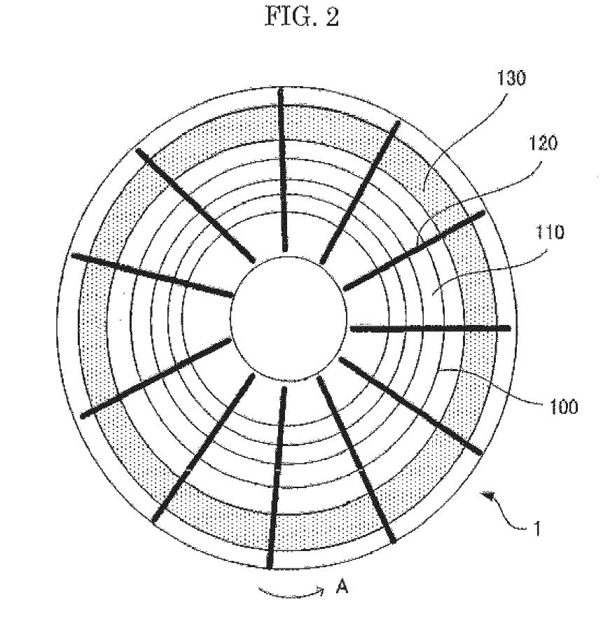

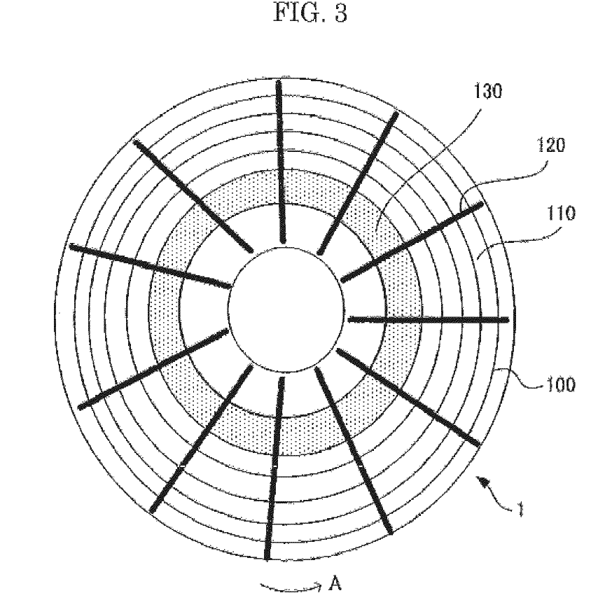

It should be noted that any of the following aspects may be selected: an aspect in which the non-patterned area 130 is provided at the intermediate circumferential part of the magnetic recording medium with respect to the radius direction as shown in FIG. 1; an aspect in which the non-patterned area 130 is provided at the outer circumferential part of the magnetic recording medium with respect to the radius direction as shown in FIG. 2; and an aspect in which the non-patterned area 130 is provided at the inner circumferential part of the magnetic recording medium with respect to the radius direction as shown in FIG. 3.

The non-patterned area 130 is a continuous magnetic band and is an indiscrete area.

### —Other Member(s)—

The above-mentioned other member(s) are not particularly limited as long as the effects of the present invention are not impaired, and may be suitably selected according to the purpose.

### (Imprint Mold Structure)

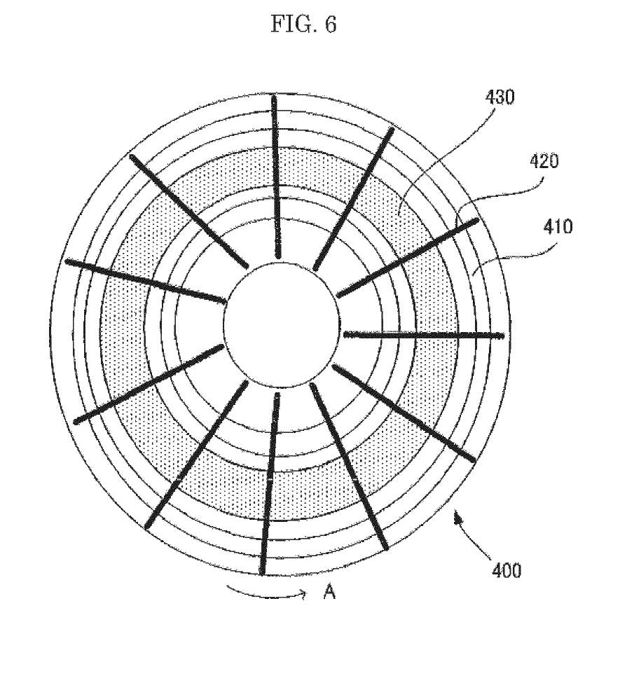

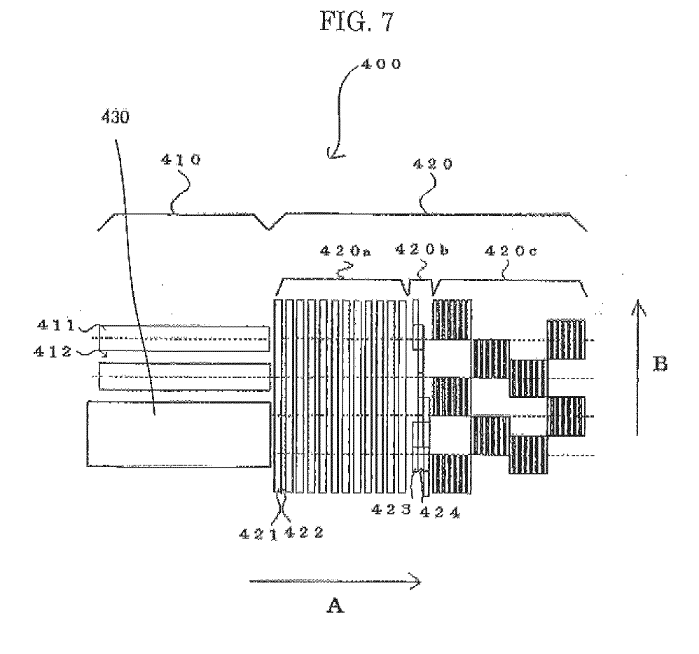

FIG. 6 is a plan view schematically showing the structure of an imprint mold structure of the present invention. FIG. 7 is a plan view partially showing components of the imprint mold structure of the present invention.

The direction of the arrow A in FIGS. 6 and 7 represents a circumferential direction, and the direction of the arrow B in FIG. 7 represents a radius direction.

Used to produce the above-mentioned magnetic recording medium 1, an imprint mold structure 400 includes at least a concavo convex pattern 410 corresponding to the data areas 110, a concavo-convex pattern 420 corresponding to the servo areas 120, and a shape 430 corresponding to the non-patterned area 130, as shown in FIGS. 6 and 7, and if necessary includes other member(s).

### —Concavo-Convex Pattern Corresponding to Data Area—

As shown in FIG. 7, the concavo-convex pattern 410 corresponding to the data areas 110 includes a concave portion 411 corresponding to the magnetic band 111, and a convex portion 412 corresponding to the nonmagnetic hand 112.

### —Concavo-Convex Pattern Corresponding to Servo Area—

As shown in FIG. 7, the concavo-convex pattern 420 corresponding to the servo areas 120 includes a concavo-convex pattern 420a corresponding to the preamble area 120a, a concavo-convex pattern 420b corresponding to the address area 120b, and a concavo-convex pattern 420c corresponding to the burst area 120c.

The concavo-convex pattern 420a includes a concave portion 421 corresponding to the magnetic portion 122, and a convex portion 422 corresponding to the nonmagnetic portion 121. The concave-convex pattern 420b includes a concave portion 423 corresponding to the magnetic portion 124, and a convex portion 424 corresponding to the nonmagnetic portion 123.

### —Shape Corresponding to Non-Patterned Area—

The shape 430 corresponding to the non-patterned area is such a shape that adjacent concave portions, the number of which is the number of tracks required (two or more), are formed.

The shape 430 corresponding to the non-patterned area is provided in at least any one of an inner circumferential part, an intermediate circumferential part and an outer circumferential part of the imprint mold structure with respect to the radius direction.

### —Other Member(s)—

The above-mentioned other member(s) are not particularly limited as long as the effects of the present invention are not impaired, and may be suitably selected according to the purpose. Examples thereof include a mold surface layer capable of separating from an imprint resist layer, and a carbon film provided as a protective film.

### <Method for Producing Imprint Mold Structure>

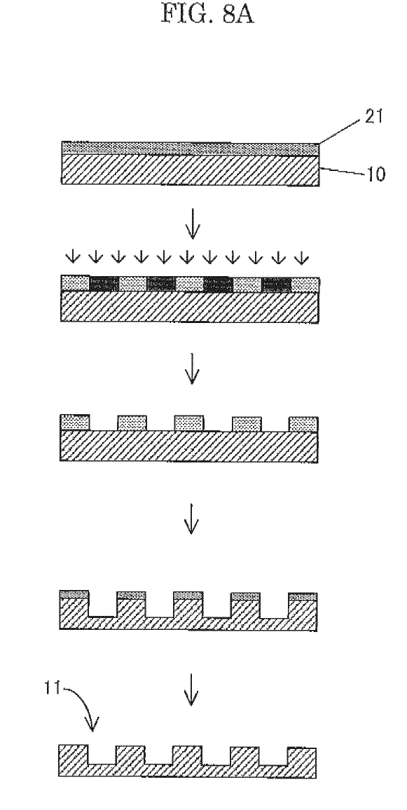

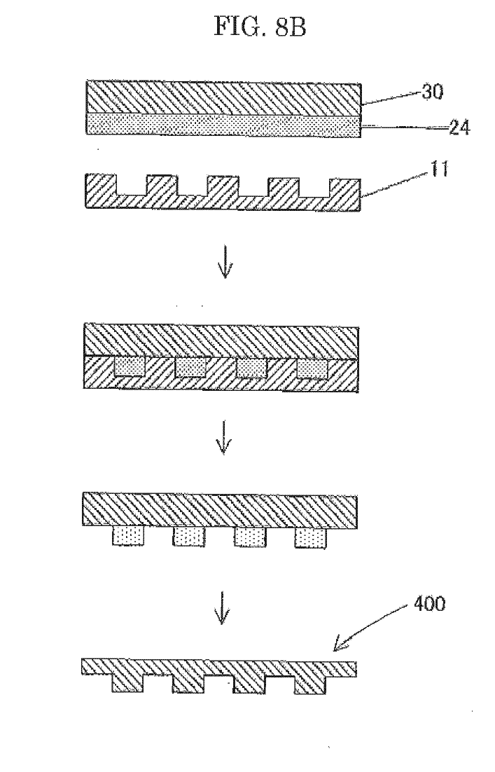

The following explains an example of a method for producing an imprint mold structure used in the present invention, referring to FIGS. 8A and 8B. It should, however, be noted that the imprint mold structure used in the present invention may be produced using a method other than the following method.

### —Production of Original Master—

FIGS. 8A and 8B are cross-sectional views together showing a method for producing an imprint mold structure.

As shown in FIG. 8A, an electron beam resist solution is applied onto a Si substrate 10 by spin coating or the like so as to form a photoresist layer 21.

Thereafter, while rotating the Si substrate 10, an electron beam modulated correspondingly to a servo signal is applied so as to form a predetermined servo pattern on the entire surface of the photoresist; for example, a servo pattern that corresponds to a servo signal and that linearly extends in radius directions from the rotational center toward each track is formed by exposure at portions corresponding to frames on the circumference. A concavo-convex pattern having a predetermined width and a predetermined track pitch is formed in data areas by exposure. Non-patterned area(s) is/are concentrically formed in the data areas by exposure such that each non-patterned area has convex shapes composed of two or more tracks on the Si substrate.

Afterward, the photoresist layer 21 is developed, the exposed portions are removed, then the substrate is selectively etched by RIE, etc. with the pattern of the photoresist layer 21 serving as a mask, and an original master 11 having a concavo-convex shape is thus obtained.

### —Production of Imprint Mold Structure—

Next, as shown in FIG. 8B, the original master 11 is pressed against a quartz substrate 30 as a substrate to be processed, one surface of which is covered with an imprint resist layer 24 made by application of an imprint resist solution containing a photocurable resin. Thus, the concavo-convex pattern formed on the original master 11 is transferred to the imprint resist layer 24.

Here, the material for the substrate to be processed is not particularly limited as long as it transmits light and has such strength as can function as a mold structure, and the material may be suitably selected according to the purpose. Examples thereof include quartz (SiO₂).

The specific meaning of the expression “transmits light” is that when light is made to enter the other surface of the substrate so as to exit from the one surface thereof where the imprint resist layer is formed, the imprint resist sufficiently cures, and that the transmittance of light from the other surface to the one surface is 50% or more.

The specific meaning of the expression “has such strength as can function as a mold structure” is that when the material is pressed against an imprint resist layer formed on a substrate of a magnetic recording medium under an average surface pressure of 4 kgf/cm², the material is not damaged.

### —Curing Step—

Thereafter, the pattern transferred to the imprint resist layer 24 is cured by ultraviolet irradiation.

### —Pattern Forming Step—

Afterward, the quartz substrate is selectively etched by RIE, etc. with the transferred pattern serving as a mask, and an imprint mold structure 400 having a concavo-convex is thus obtained.

Although the imprint mold structure 400 is produced by nanoimprint lithography (NIL) utilizing an ultraviolet ray, the imprint mold structure of the present invention may be otherwise produced, for example by nanoimprint lithography (NIL) utilizing heat in which a Ni conductive layer is provided on the original master 11 having the concavo-convex shape and the Ni conductive layer is separated from the original master 11 by Ni electroforming so as to obtain a Ni mold.

### (Method for Producing Magnetic Recording Medium)

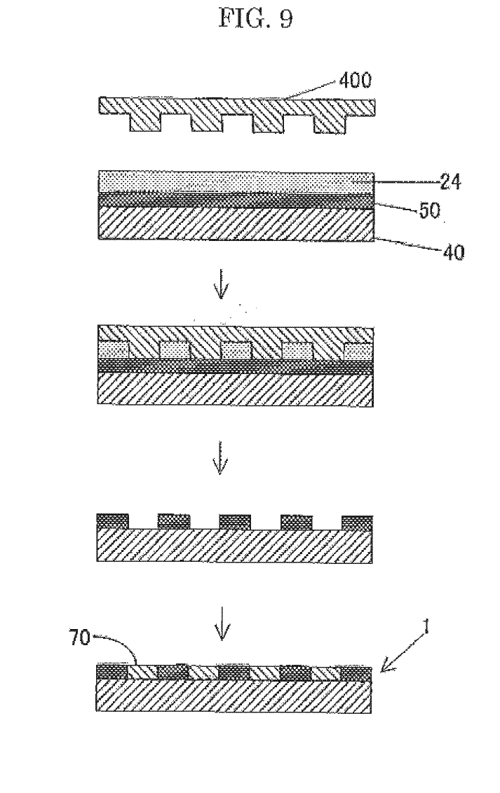

Referring to FIG. 9, the following explains a method for producing a magnetic recording medium (a discrete track medium, a patterned medium, etc.) using the imprint mold structure. It should, however, be noted that the method of the present invention for producing a magnetic recording medium may differ from the following method as long as it employs an imprint mold structure.

As shown in FIG. 9, by pressing the imprint mold structure 400 against a substrate 40 for a magnetic recording medium 1, over which a magnetic layer 50 and an imprint resist layer 24 made by application of an imprint resist solution are formed in this order, the concavo-convex pattern formed on the imprint mold structure 400 is transferred to the imprint resist layer 24.

Thereafter, the magnetic layer 50 is subjected to selective etching such as RIE, while the imprint resist layer 24 to which the concavo-convex pattern of the imprint mold structure 400 has been transferred serves as a mask, so as to form the concavo-convex pattern in the magnetic layer 50, then concave portions in the concavo-convex pattern are filled with a nonmagnetic material 70, the surface is flattened, a protective film and/or the like are/is if necessary formed over the surface, and the magnetic recording medium 1 is thus obtained.

A magnetic recording medium produced by the method of the present invention for producing a magnetic recording medium is preferably either a discrete-type magnetic recording medium or a patterned magnetic recording medium.

### EXAMPLES

The following explains Examples of the present invention. It should, however, be noted that the present invention is not confined to these Examples in any way.

### Example 1

### Production of Imprint Mold Structure

### <<Production of Original Master>>

An electron beam resist was applied onto a disc-shaped Si substrate of 8 inches in diameter by spin coating so as to have a thickness of 100 nm.

Thereafter, the electron beam resist was exposed using a rotary electron beam exposure apparatus so as to have desired patterns, then the exposed resist was developed, and the electron beam resist having concavo-convex patterns was thus formed on the Si substrate.

The Si substrate was subjected to reactive ion etching while the electron beam resist having the concavo-convex patterns served as a mask, such that a concavo-convex shape was formed on the Si substrate.

The remaining electron beam resist was removed by washing with a solvent capable of dissolving the resist, which was followed by drying, and an original master was thus obtained.

Here, the concavo-convex patterns are broadly divided into a concavo-convex pattern in data areas and a concavo-convex pattern in servo areas.

The concavo-convex pattern in the data areas had a convex portion width of 120 nm and a concave portion width of 30 nm (track pitch=150 nm).

In the data areas, a concave-convex pattern corresponding to a data address mark for detecting a data sector was formed on a data portion by an electron beam exposure process, which was followed by developing and etching, and a concavo-convex shape was thus formed on the Si substrate. By doing so, the pattern “001001 . . . ” with bit lengths of 40 nm, 50 nm and 60 nm was produced as the data address mark so as to have a length of 8 bytes.

As for the servo areas, the reference signal length was 90 nm and the total sector number was 50, and each servo area was composed of a preamble portion (45 bits), a SAM portion (10 bits), a sector code portion (8 bits), a cylinder code portion (32 bits) and a burst portion.

The SAM portion represented “0000101011”, the concavo-convex pattern in the sector code portion was formed utilizing binary conversion, and the concavo-convex pattern in the cylinder code portion was formed utilizing gray conversion.

The concavo-convex pattern in the burst portion was based upon an ordinary phase burst signal (16 bits) and was formed utilizing Manchester encoding.

By electron beam exposure and patterning, non-patterned areas were formed substantially concentrically in a position (inner circumferential part) which was 14 mm apart from the center in radius, in a position (intermediate circumferential part) which was 22 mm apart from the center in radius, and in a position (outer circumferential part) which was 30 mm apart from the center in radius respectively, such that each non-patterned area had convex shapes composed of two tracks on the Si substrate.

Thereafter, a novolac-based resist (MR-I 7000E, produced by micro resist technology GmbH) was formed on a quartz substrate by spin coating (at a rotational speed of 3,600 rpm) so as to have a thickness of 100 nm.

Then nanoimprinting was carried out using the original master as a mold. The quartz substrate was subjected to RIE based upon the concavo-convex resist pattern after the nanoimprinting, with CHF₃ used as an etchant, and an imprint mold structure 1 was thus obtained. Additionally, a release layer was formed by a wet method on a front surface (surface to be pressed against a resist), of the produced imprint mold structure 1. EGC-1720 (produced by Sumitomo 3M Limited) was used as a release agent which constituted the release layer.

### <Production of Magnetic Recording Medium>

Layers were formed over a 2.5 inch glass substrate in the following order so as to produce a magnetic recording medium.

In the magnetic recording medium produced, there were a soft magnetic layer, a first nonmagnetic orientation layer, a second nonmagnetic orientation layer, a magnetic layer (also referred to as “magnetic recording layer”), a protective layer and a lubricant layer formed in this order.

The soft magnetic layer, the first nonmagnetic orientation layer, the second nonmagnetic orientation layer, the magnetic recording layer and the protective layer were formed by sputtering, and the lubricant layer was formed by dipping.

### <<Formation of Soft Magnetic Layer>>

As the soft magnetic layer, a layer made of CoZrNb was formed so as to have a thickness of 20 nm.

Specifically, the glass substrate was set facing a CoZrNb target, Ar gas was introduced such that the pressure stood at 0.15 Pa, and the soft magnetic layer was deposited by DC sputtering.

### <<Formation of First Nonmagnetic Orientation Layer>>

As the first nonmagnetic orientation layer, a layer made of Ti was formed so as to have a thickness of 5 nm.

Specifically, the glass substrate and the soft magnetic layer were set facing a Ti target, Ar gas was introduced such that the pressure stood at 0.1 Pa, and a Ti seed layer was deposited as the first nonmagnetic orientation layer by DC sputtering so as to have a thickness of 5 nm. <<Formation of Second Nonmagnetic Orientation Layer>>

Thereafter, as the second nonmagnetic orientation layer, a layer made of Ru was formed so as to have a thickness of 1 nm.

Specifically, the glass substrate, the soft magnetic layer and the first nonmagnetic orientation layer were set facing a Ru target, Ar gas was introduced such that the pressure stood at 0.5 Pa, and a Ru layer was deposited as the second nonmagnetic orientation layer by DC sputtering so as to have a thickness of 1 nm.

### <<Formation of Magnetic Recording Layer>>

Subsequently, as the magnetic recording layer, a CoPtCr—SiO₂ layer was formed so as to have a thickness of 25 nm.

Specifically, the glass substrate, the soft magnetic layer, the first nonmagnetic orientation layer and the second nonmagnetic orientation layer were set facing a CoPtCr—SiO₂ target, Ar gas was introduced such that the pressure stood at 0.1 Pa, and the magnetic recording layer was formed by DC sputtering.

### <<Formation of Protective Layer>>

The glass substrate and the above-mentioned layers were set facing a C target, Ar gas was introduced such that the pressure stood at 0.5 Pa, and a C protective layer was formed as the protective layer by DC sputtering so as to have a thickness of 2 nm.

The coercive force of the magnetic recording medium was adjusted to 334 kA/m (4.2 kOe).

### <<Formation of Imprint Resist Layer>>

An imprint resist layer was formed on the protective layer by spin coating (at a rotational speed of 3,600 rpm) so as to have a thickness of 100 nm, using an acrylic resist (PAR-01-500, produced by Toyo Gosei Co., Ltd) as an imprint resist composition.

### <<Transfer Step>>

The mold structure was placed such that its surface on the side of the concavo-convex pattern was facing the substrate covered with the imprint resist layer, then the mold structure was closely attached to the substrate covered with the imprint resist layer, under a pressure of 3 MPa for 10 seconds while applying an ultraviolet ray at a rate of 10 mJ/cm².

After the above-mentioned step, the mold structure was separated from the substrate covered with the imprint resist layer.

Subsequently, the imprint resist layer remaining in concave portions in the concavo-convex pattern formed on the imprint resist layer by transferring the concavo-convex pattern of the mold structure onto the imprint resist layer was removed by O₂ reactive chemical etching. This O₂ reactive chemical etching was performed such that the magnetic layer was exposed at the concave portions.

### <<Magnetic Pattern Portion Forming Step>>

After the removal of the imprint resist layer remaining in the concave portions, the magnetic layer was processed so as to have a concavo-convex shape.

Ion beam etching was employed to process the magnetic layer.

Specifically, Ar gas was used, the ion acceleration energy was set at 500 eV, and an ion beam was applied to the magnetic layer from a direction perpendicular to the magnetic layer.

After the magnetic layer was thus processed, the resist remaining on the magnetic layer was removed by O₂ reactive chemical etching.

### <<Nonmagnetic Pattern Portion Forming Step>>

After the magnetic layer was thus processed, a SiO₂ layer was formed as a nonmagnetic material-containing layer by sputtering so as to have a thickness of 50 nm, then the SiO₂ layer was partially removed by ion beam etching such that the surface of the magnetic layer and the surface of the nonmagnetic layer had no level difference. Subsequently, a C protective film was again deposited so as to have a thickness of 4 nm, then a PFPE lubricant was applied by dipping so as to have a thickness of 1.5 nm. The magnetic recording medium of Example 1 was thus produced.

### Example 2

A magnetic recording medium of Example 2 was produced in the same manner as in Example 1, except that, by electron beam exposure and patterning, non-patterned areas were formed substantially concentrically in the position (inner circumferential part) which was 14 mm apart from the center in radius, in the position (intermediate circumferential part) which was 22 mm apart from the center in radius, and in the position (outer circumferential part) which was 30 mm apart from the center in radius respectively, such that each non-patterned area had convex shapes composed of five tracks on the Si substrate.

### Example 3

A magnetic recording medium of Example 3 was produced in the same manner as in Example 1, except that, by electron beam exposure and patterning, non-patterned areas were formed substantially concentrically in the position (inner circumferential part) which was 14 mm apart from the center in radius, in the position (intermediate circumferential part) which was 22 mm apart from the center in radius, and in the position (outer circumferential part) which was 30 mm apart from the center in radius respectively, such that each non-patterned area had convex shapes composed of 10 tracks on the Si substrate.

### Comparative Example 1

A magnetic recording medium of Comparative Example 1 was produced in the same manner as in Example 1, except that, by electron beam exposure and patterning, non-patterned areas were formed substantially concentrically in the position (inner circumferential part) which was 14 mm apart from the center in radius, in the position (intermediate circumferential part) which was 22 mm apart from the center in radius, and in the position (outer circumferential part) which was 30 mm apart from the center in radius respectively, such that each non-patterned area had a convex shape composed of one track on the Si substrate.

Next, evaluations of reading errors were carried out in the following manner regarding Examples 1 to 3 and Comparative Example 1. The results are shown in Table 1.

### <Evaluation of Reading Error>

Using a Guzik spin stand, a tri-pad negative-pressure femto slider and a head having a read width of 90 nm, a servo portion was brought into an on-track state, a magnetic pattern recorded at a fixed frequency on a data portion was read out into an oscilloscope, and the numbers of bits in areas where the amplitude strength was equivalent to 10% or less of the normal amplitude strength were counted. Table 1 shows evaluations of the repetition of errors, carried out by repeating the measurement 50 times for each same place; and the averages of the numbers of error bits, obtained by measuring 10 samples each to evaluate differences among the samples, as ratios to the average of the numbers of error bits concerning Example 1 (two tracks). Reading errors and the repetition of errors were evaluated in accordance with the following criteria.

### [Evaluation Criteria for Repetition of Error]

A: When the measurement was repeated 50 times for the same sample, the number of errors made by the same bit was less than 4.

B: When the measurement was repeated 50 times for the same sample, the number of errors made by the same bit was 4 or more.

### [Evaluation Criteria for Reading Error]

A: Favorable (Practical use was possible.)

B: Reading error arose many times (Practical use was impossible.)

TABLE 1-1

| | | | | | Comp. |
|---|---|---|---|---|---|
| | | Ex. 1 | Ex. 2 | Ex. 3 | Ex. 1 |
| Inner | Number of tracks included in | 2 | 5 | 10 | 1 |
| circumferential | non-patterned area | | | | |
| part (14 mm | Evaluation of repetition of error | A | A | A | B |
| apart from center | Ratio of number of error bits (with number | 1 | 0.9 | 0.9 | 7.9 |
| in radius) | concerning Example 1 serving as standard) | | | | |
| | Evaluation of reading error | A | A | A | B |

TABLE 1-2

| | | | | | Comp. |
|---|---|---|---|---|---|
| | | Ex. 1 | Ex. 2 | Ex. 3 | Ex. 1 |
| Intermediate | Number of tracks included in | 2 | 5 | 10 | 1 |
| circumferential | non-patterned area | | | | |
| part (22 mm | Evaluation of repetition of error | A | A | A | B |
| apart from center | Ratio of number of error bits (with number | 1 | 0.9 | 0.9 | 8.8 |
| in radius) | concerning Example 1 serving as standard) | | | | |
| | Evaluation of reading error | A | A | A | B |

TABLE 1-3

| | | | | | Comp. |
|---|---|---|---|---|---|
| | | Ex. 1 | Ex. 2 | Ex. 3 | Ex. 1 |
| Outer | Number of tracks included in | 2 | 5 | 10 | 1 |
| circumferential | non-patterned area | | | | |
| part (30 mm | Evaluation of repetition of error | A | A | A | B |
| apart from center | Ratio of number of error bits (with number | 1 | 1 | 1 | 8.7 |
| in radius) | concerning Example 1 serving as standard) | | | | |
| | Evaluation of reading error | A | A | A | B |

The results shown in Tables 1-1 to 1-3 show that since the provision of a non-patterned area composed of two or more tracks makes it possible to reduce the number of errors in the same place to two or less when the measurement is repeated 50 times, the magnetic recording medium of Example 1 will be capable of recovering from errors by rereading, utilizing an error recovery algorithm at the time of error, a redundancy code and an error correctable code generally recorded simultaneously with data in a drive. Also, it was found that the number of error bits was small and thus the occurrence of reading errors could be prevented.

As to the magnetic recording medium produced using the imprint mold structure of the present invention, since the data areas have one or more non-patterned areas which do not include a pattern to write user data on, it is possible to avoid, particularly in a maker-only area where information important to boot and control an HDD is recorded and reproduced, the risk of causing recording and/or reproduction failure attributable to offsetting of a trace of a head and a trace of a patterned track in the non-patterned area(s), and thus it is possible to remove booting failure and operation failure that are serious problems with the HDD. Accordingly, the magnetic recording medium can be suitably used for both discrete track media and patterned media, for example.

What is claimed is:

1. An imprint mold structure for producing a magnetic recording medium, the imprint mold structure comprising:
a first pattern corresponding to servo areas,
a second pattern corresponding to data areas, and
a shape corresponding to one or more non-patterned areas,
wherein the magnetic recording medium comprises the servo areas where servo data is to be recorded, and the data areas which include a pattern to write user data on, and
wherein the data areas have the one or more non-patterned areas which do not include a pattern to write user data on, and which are substantially concentric areas each composed of two or more adjacent tracks located in the data areas.

2. The imprint mold structure according to claim 1, wherein each pattern is one of a discrete pattern and a dot pattern.

3. The imprint mold structure according to claim 1, wherein the one or more non-patterned areas are provided in at least any one of an inner circumferential part, an intermediate circumferential part and an outer circumferential part of the magnetic recording medium with respect to a radius direction.

4. A method for producing a magnetic recording medium, comprising:
using an imprint mold structure for producing a magnetic recording medium, the imprint mold structure comprising a first pattern corresponding to servo areas, a second pattern corresponding to data areas, and a shape corresponding to one or more non-patterned areas,
wherein the magnetic recording medium comprises the servo areas where servo data is to be recorded, and the data areas which include a pattern to write user data on, and
wherein the data areas have the one or more non-patterned areas which do not include a pattern to write user data on, and which are substantially concentric areas each composed of two or more adjacent tracks located in the data areas.

5. A magnetic recording medium obtained by a method for producing a magnetic recording medium, the method comprising:
using an imprint mold structure for producing a magnetic recording medium, the imprint mold structure comprising a first pattern corresponding to servo areas, a second pattern corresponding to data areas, and a shape corresponding to one or more non-patterned areas,
wherein the magnetic recording medium comprises the servo areas where servo data is to be recorded, and the data areas which include a pattern to write user data on, and
wherein the data areas have the one or more non-patterned areas which do not include a pattern to write user data on, and which are substantially concentric areas each composed of two or more adjacent tracks located in the data areas.
